(19) United States
(12) Patent Application Publication
(10) Pub. No.: US 2026/0194081 A1
(43) Pub. Date: Jul. 9, 2026

(54) CYLINDER DEVICE

(71) Applicant: SMC CORPORATION, Tokyo (JP)

(72) Inventors: Ken NAKAJIMA, Tsukubamirai-shi (JP); Eun-Ho JEOUNG, Seoul (KR); Seon-Kwan KIM, Seoul (KR)

(73) Assignee: SMC CORPORATION, Tokyo (JP)

(21) Appl. No.: 19/135,513

(22) PCT Filed: Sep. 12, 2023
(86) PCT No.: PCT/JP2023/033154

§ 371 Date: Jun. 4, 2025

(30) Foreign Application Priority Data
Dec. 9, 2022 (JP) 2022-197174

(51) Int. Cl. F15B 15/14

(52) U.S. Cl. CPC F15B 15/1438; F15B 15/1447

(57) ABSTRACT

A cylinder device includes a first cylinder chamber that has a first piston; a second cylinder chamber that has a second piston; a first rod that is connected to the first piston; a second rod that partially overlaps with the first rod in the radial direction and protrudes from a body; and a conversion mechanism that converts displacement of one section in the axial direction of the first rod into displacement in a rotational direction of the second rod, and transmits displacement of another section in the axial direction of the first rod as displacement in the axial direction of the second rod. The second piston is connected to the second rod.

### TECHNICAL FIELD

The present invention relates to a cylinder device that causes a rod to be displaced in an axial direction and a rotational direction.

### BACKGROUND ART

In an automated factory line, a clamp cylinder (a cylinder device) is used to clamp a target object. Such a cylinder device clamps the target object by utilizing a rotational motion at an extruded end of the rod, and a linear motion in the axial direction toward a retracted end of the rod.

The cylinder device used for clamping is equipped with a conversion mechanism that converts an axial displacement of a piston into a linear displacement of the rod, and into a displacement thereof in a rotational direction (refer to JP 2017-227223 A).

### SUMMARY OF THE INVENTION

In the cylinder device, there are cases in which it is required to increase the clamping force that presses down on the target object. In such a case, a boosting mechanism is used in which a boosting piston is added to the cylinder device, and the rod is driven by two pistons.

However, in a conventional boosting mechanism, the two pistons are driven with equal stroke lengths, and a problem is brought about in that the overall length of the cylinder device becomes long.

The present invention has the object of solving the aforementioned problem.

One aspect of the following disclosure is characterized by a cylinder device, comprising a first cylinder chamber including a first piston, a second cylinder chamber including a second piston, a first rod connected to the first piston, a second rod configured to partially overlap with the first rod in a radial direction, and to project out from a body, and a conversion mechanism configured to convert one part of a displacement of the first rod in an axial direction into a displacement of the second rod in a rotational direction, and to transmit another part of the displacement of the first rod in the axial direction as a displacement of the second rod in the axial direction, wherein the second piston is connected to the second rod.

The cylinder device according to the aforementioned aspect is capable of suppressing the stroke length of the second piston to within a stroke range of the second rod, and therefore, it is possible to suppress the overall length of the cylinder device.

The above and other objects, features, and advantages of the present invention will be more easily understood from the following description of the embodiments, which are described with reference to the accompanying drawings.

### BRIEF DESCRIPTION OF DRAWINGS

FIG. 1 is a cross-sectional view of a cylinder device according to a first embodiment;

FIG. 2 is a perspective view showing an exploded state of the cylinder device of FIG. 1;

FIG. 3A is an explanatory diagram showing a positional relationship between a first rod, a second rod, a first pin groove, and a second pin groove of the cylinder device of FIG. 1, and FIG. 3B is a schematic diagram showing a positional relationship between a displacement switching groove and a rotation groove of the second rod, a support pin, and a link pin that are expanded in a plane;

FIG. 4A is a cross-sectional view of the cylinder device of FIG. 1 in a state in which the rod is positioned at an extruded end (an extruded end position), and FIG. 4B is a schematic diagram showing a position of the support pin in the displacement switching groove, and a position of the link pin in the rotation groove in the state shown in FIG. 4A;

FIG. 5A is a cross-sectional view of the cylinder device of FIG. 1 in a state (a rotation end position) in which a rotation of the rod is completed, and FIG. 5B is a schematic diagram showing a position of the support pin in the displacement switching groove, and a position of the link pin in the rotation groove in the state shown in FIG. 5A;

FIG. 6A is a cross-sectional view of the cylinder device of FIG. 1 in a state in which the rod is positioned at a retracted end (a retracted end position), and FIG. 6B is a schematic diagram showing a position of the support pin in the displacement switching groove, and a position of the link pin in the rotation groove in the state shown in FIG. 6A;

FIG. 7A is a cross-sectional view of the cylinder device according to a first exemplary modification of the first embodiment, and FIG. 7B is a cross-sectional view of the cylinder device according to a second exemplary modification of the first embodiment;

FIG. 8 is a perspective view of a body according to a third exemplary modification of the first embodiment;

FIG. 9 is a cross-sectional view of a cylinder device according to a second embodiment;

FIG. 10 is a cross-sectional view of the cylinder device according to an exemplary modification of the second embodiment;

FIG. 11A is a cross-sectional view of a cylinder device according to a third embodiment, and FIG. 11B is a cross-sectional view of the cylinder device of FIG. 11A at a rotation end position; and

FIG. 12A is a cross-sectional view of the cylinder device according to a first exemplary modification of the third embodiment, and FIG. 12B is a cross-sectional view of the cylinder device according to a second exemplary modification of the third embodiment.

### DETAILED DESCRIPTION OF THE INVENTION

### First Embodiment

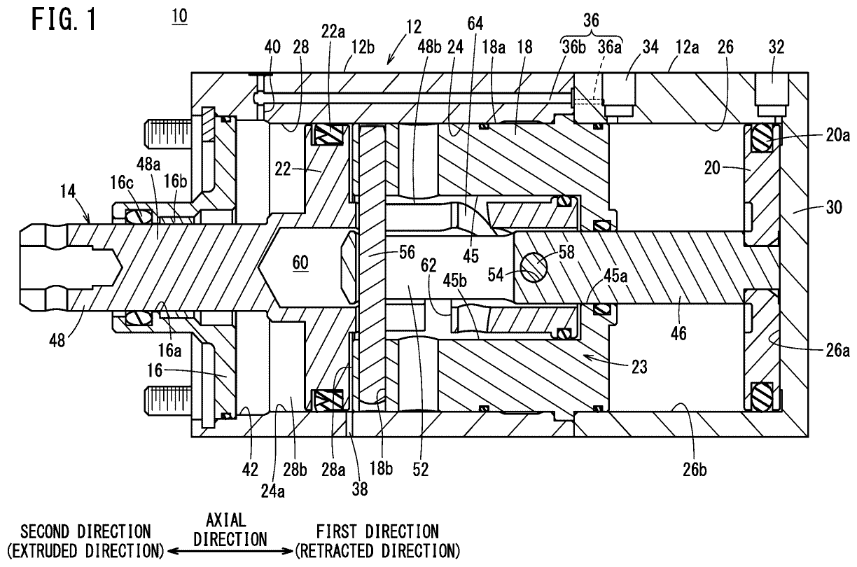

A cylinder device 10 according to the present embodiment shown in FIG. 1 is a clamp cylinder. The cylinder device 10 is used, for example, in order to fix a workpiece that serves as an object to be machined in an automated production line. The cylinder device 10 is equipped with a rod 14 that projects out from a body 12. The rod 14 carries out a rotational motion at an extruded end (an unclamped end), and after the rotational motion, carries out a linear displacement toward a retracted end (a clamped end). Moreover, in the present specification, an extending direction of the rod 14 is also referred to as an axial direction. Further, in the axial direction, the direction toward the retracted end is also referred to as a first direction, and the direction toward the extruded end is also referred to as a second direction.

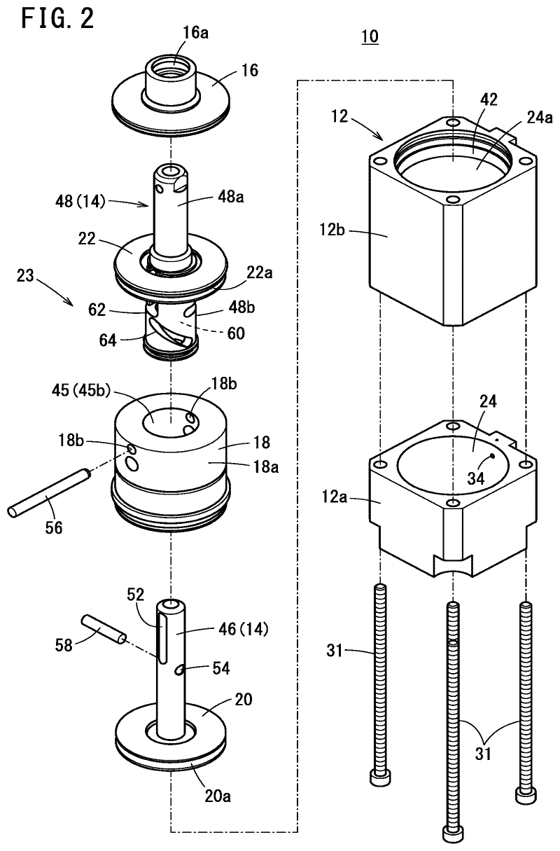

As shown in FIG. 1 and FIG. 2, the cylinder device 10 is equipped with the body 12 (a cylinder tube), the rod 14, a rod cover 16, a partition wall member 18, a first piston 20, a second piston 22, and a conversion mechanism 23.

The body 12 is a tubular member having an outer shape in the form of a rectangular parallelepiped. The body 12 includes, in the interior thereof, a cylinder chamber 24 having a circular cross-sectional shape. The cylinder chamber 24 extends in the axial direction. The cylinder chamber 24, as shown in FIG. 1, is partitioned by the partition wall member 18 into a first cylinder chamber 26 and a second cylinder chamber 28. An end part of the cylinder chamber 24 in the first direction is closed by an end wall 30 of the body 12. The body 12, for example, is formed from a material such as metal or resin or the like.

As shown in FIG. 2, the body 12 includes a first body 12a that is positioned closer to the first direction side, and a second body 12b that is positioned closer to the second direction side in the axial direction. The first body 12a and the second body 12b are connected in the axial direction by fastening rods 31 (tie rods). The first body 12a includes the first cylinder chamber 26 in the interior thereof. An end part of the first cylinder chamber 26 in the first direction is closed by the end wall 30 of the first body 12a.

The first body 12a includes a first fluid supply/discharge unit 32 and a second fluid supply/discharge unit 34 that serve to supply and discharge fluid to and from the first cylinder chamber 26. The first fluid supply/discharge unit 32 opens at or in close proximity to an end part of the first cylinder chamber 26 in the first direction. The first fluid supply/discharge unit 32 supplies and discharges a pressurized fluid, through an external pipe, to and from an empty chamber 26a of the first cylinder chamber 26 on the first direction side. The second fluid supply/discharge unit 34 opens at or in close proximity to an end part of the first cylinder chamber 26 in the second direction. The second fluid supply/discharge unit 34 supplies and discharges a pressurized fluid, through an external pipe, to and from an empty chamber 26b of the first cylinder chamber 26 on the second direction side.

A first connecting flow path 36a branches off and extends out from the second fluid supply/discharge unit 34. The first connecting flow path 36a is a flow path formed in the interior of the first body 12a and extends toward the second direction. The first connecting flow path 36a communicates with a second connecting flow path 36b of the second body 12b at an end part of the first body 12a in the second direction.

The second body 12b, as shown in FIG. 2, includes a through hole 24a that constitutes a part of the cylinder chamber 24. As shown in FIG. 1, concerning the through hole 24a, an end part thereof in the first direction is blocked by the partition wall member 18, and an end part thereof in the second direction is blocked by the rod cover 16. The second cylinder chamber 28 is formed between the partition wall member 18 and the rod cover 16. Furthermore, the second body 12b includes a first port 38 and a second port 40 that communicate with the second cylinder chamber 28, and the second connecting flow path 36b. The first connecting flow path 36a and the second connecting flow path 36b constitute a connecting flow path 36 that serves to supply and discharge fluid to and from the second cylinder chamber 28.

The second connecting flow path 36b is a flow path that extends in the axial direction in the interior of the second body 12b. An end part of the second connecting flow path 36b in the first direction is connected to the first connecting flow path 36a. An end part of the second connecting flow path 36b in the second direction is connected to the second port 40.

The first port 38 opens at or in close proximity to an end part of the second cylinder chamber 28 in the first direction. In the present embodiment, the first port 38 is a ventilation hole that communicates with the exterior, and that maintains an empty chamber 28a on the first direction side of the second piston 22 at atmospheric pressure. The second port 40 communicates, through the connecting flow path 36 (the first connecting flow path 36a and the second connecting flow path 36b), with the second fluid supply/discharge unit 34. The second port 40 opens at or in close proximity to an end part of the second cylinder chamber 28 in the second direction. The second port 40 supplies and discharges a pressurized fluid, through the second fluid supply/discharge unit 34, to and from an empty chamber 28b on the second direction side of the second piston 22.

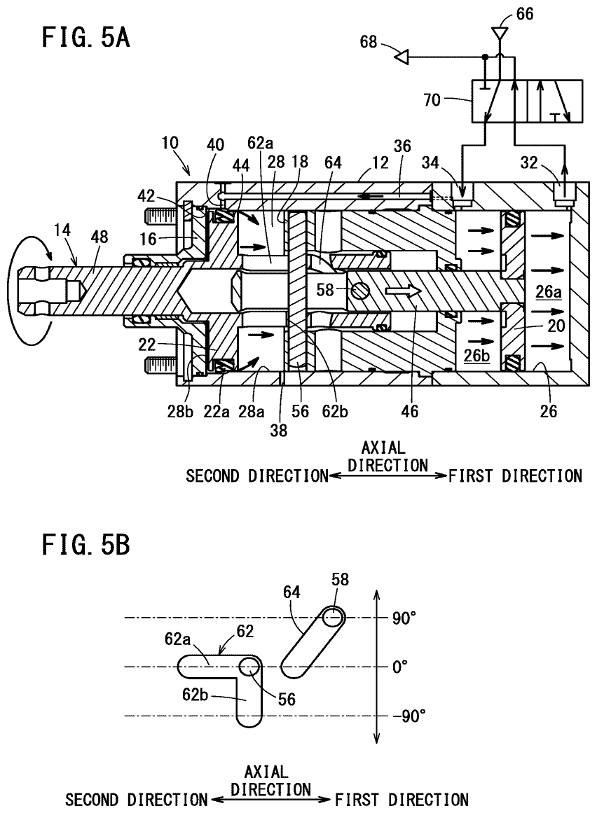

The second cylinder chamber 28 includes an expanded diameter portion 42 in close proximity to an end part thereof in the second direction. The expanded diameter portion 42 has a groove shape that extends over the entire circumferential direction of the second cylinder chamber 28. An inner diameter of the expanded diameter portion 42 is larger than outer diameters of the second piston 22 and a packing 22a. The expanded diameter portion 42, in a state in which the second piston 22 is positioned at the stroke end part (an extruded end position) in the second direction, is positioned on the outer circumference of the second piston 22. The expanded diameter portion 42 is spaced apart from the second piston 22 at the stroke end part (the extruded end position) in the second direction. A gap between the expanded diameter portion 42 and the second piston 22 forms a leakage flow path 44 that causes the pressurized fluid in the second port 40 to leak toward the empty chamber 28a side (refer to FIG. 5A). The expanded diameter portion 42, at the extruded end position of the second piston 22, communicates with the empty chamber 28a and the empty chamber 28b on both sides of the second piston 22.

As shown in FIG. 1, the rod cover 16 has a T-shaped cross section. The rod cover 16 includes a cover hole 16a in the center thereof. The rod 14 (a second rod 48) is inserted through the cover hole 16a. The cover hole 16a supports the second rod 48 in a manner so as to be capable of being displaced in the axial direction and the rotational direction. The rod cover 16 further includes a rod bushing 16b and a rod packing 16c. The rod bushing 16b is disposed in the cover hole 16a. The rod bushing 16b slides against the outer circumferential surface of the rod 14, and thereby guides the displacement of the rod 14 along the axial direction. The rod packing 16c prevents leakage of fluid along the cover hole 16a from occurring.

As shown in FIG. 2, the partition wall member 18 is a cylindrically shaped member, and has an outer circumferential surface 18a on the outer circumferential part thereof that is placed in intimate contact with the cylinder chamber 24. The partition wall member 18 is fixed to the body 12 by a non-illustrated set screw, so as to be incapable of being displaced in the axial direction and the rotational direction.

As shown in FIG. 1, the partition wall member 18 includes a through hole 45 that penetrates therethrough in the axial direction at the center thereof. The through hole 45 includes a partition wall hole 45a and an accommodation hole 45b. The partition wall hole 45a is positioned on the first direction side, and has an inner diameter that is equal to or slightly larger than that of a first rod 46. The partition wall hole 45a allows the first rod 46 to be inserted therethrough so as to be capable of being displaced in the axial direction. A packing is provided in the partition wall hole 45a, and prevents leakage of fluid along the outer circumferential surface of the first rod 46 from occurring. The accommodation hole 45b is positioned on the second direction side of the partition wall hole 45a, and is connected to the partition wall hole 45a. The accommodation hole 45b has an inner diameter that is larger than that of the partition wall hole 45a. The accommodation hole 45b has an inner diameter capable of accommodating the second rod 48 so as to be capable of being displaced in the axial direction. An end part of the accommodation hole 45b in the second direction opens toward the second cylinder chamber 28.

The partition wall member 18 includes a retaining hole 18b positioned in close proximity to an end part of the partition wall member 18 in the second direction. The retaining hole 18b is a hole that penetrates in the radial direction through the partition wall member 18, and serves to retain a support pin 56. The support pin 56 is formed as a cylindrically shaped rod that extends in a radial direction perpendicular to the axial direction. The partition wall member 18 retains the support pin 56 with respect to the body 12 in a manner so as to be incapable of being displaced in the rotational direction and the axial direction.

The first piston 20 is disposed in the first cylinder chamber 26. The first piston 20 includes a packing 20a on the outer circumferential part thereof, and partitions the first cylinder chamber 26 into the empty chamber 26a on the first direction side, and the empty chamber 26b on the second direction side. The first piston 20, due to a difference in pressure between the empty chamber 26a and the empty chamber 26b, is displaced in the axial direction along the first cylinder chamber 26.

The second piston 22 is disposed in the second cylinder chamber 28. The second piston 22 includes the packing 22a on the outer circumferential part thereof. The second piston 22 is displaced in the axial direction along the second cylinder chamber 28. The rod 14 is connected to the first piston 20 and the second piston 22.

The rod 14 includes the first rod 46 and the second rod 48. The first rod 46 is disposed along the central axis of the body 12, and an end part thereof in the first direction is connected to the first piston 20. The first rod 46 is displaced together with the first piston 20. The first rod 46 extends in the second direction from the first piston 20. The first rod 46 is inserted through the partition wall hole 45a of the partition wall member 18, and extends toward the second cylinder chamber 28. A part of the first rod 46 is accommodated in a shaft hole 60 of a cylindrical portion 48b of the second rod 48. The first rod 46 overlaps in the radial direction with the second rod 48. The first rod 46 may overlap in the radial direction from the outer circumferential side of the second rod 48. The first rod 46 includes, in the overlapping portion with the second rod 48, a first pin groove 52 and a pin hole 54.

As shown in FIG. 1 and FIG. 2, the first pin groove 52 penetrates through the first rod 46 in the radial direction, which is orthogonal to the axial direction. The first pin groove 52, when viewed from the side, extends in a slit shape in the axial direction. The length of the first pin groove 52 in the axial direction is set to be equal to or greater than the stroke length of the first piston 20. As shown in FIG. 1, the support pin 56, which is supported by the partition wall member 18, is inserted into the first pin groove 52. The support pin 56 is fixed in the axial direction and the rotational direction to the body 12. Accordingly, displacement of the first rod 46 in the rotational direction is restricted by the support pin 56 and the first pin groove 52, and the first rod 46 is capable of being displaced only in the axial direction.

The pin hole 54 is positioned away from the first pin groove 52 in the first direction. The pin hole 54 penetrates in the radial direction through the first rod 46. A link pin 58 is inserted through the pin hole 54. The penetrating direction of the pin hole 54 is shifted by 90 degrees in the circumferential direction from the penetrating direction of the first pin groove 52. Accordingly, the link pin 58 is inserted through the pin hole 54 in an orientation that is orthogonal to that of the support pin 56.

The second rod 48 is disposed on the second direction side of the first rod 46. The second rod 48 is disposed along the axial direction of the body 12, and penetrates in the axial direction through the second cylinder chamber 28. The second rod 48 includes a rod portion 48a that projects out from the body 12, and the cylindrical portion 48b positioned on the first direction side of the rod portion 48a. The rod portion 48a is inserted through the cover hole 16a of the rod cover 16. The rod portion 48a projects out from the rod cover 16.

The cylindrical portion 48b is positioned on the first direction side of the rod portion 48a. The cylindrical portion 48b is a cylindrically shaped portion having a larger diameter than the rod portion 48a. The cylindrical portion 48b includes, in the interior thereof, the shaft hole 60 which has a circular cross-sectional shape. The shaft hole 60 extends in the axial direction, and opens at an end part thereof in the first direction. The shaft hole 60 accommodates the first rod 46 so as to be capable of being displaced in the axial direction. The second piston 22 is connected to the cylindrical portion 48b. According to the present embodiment, the second piston 22 and the second rod 48 are integrally connected, and the second piston 22 is incapable of being displaced in the rotational direction with respect to the second rod 48.

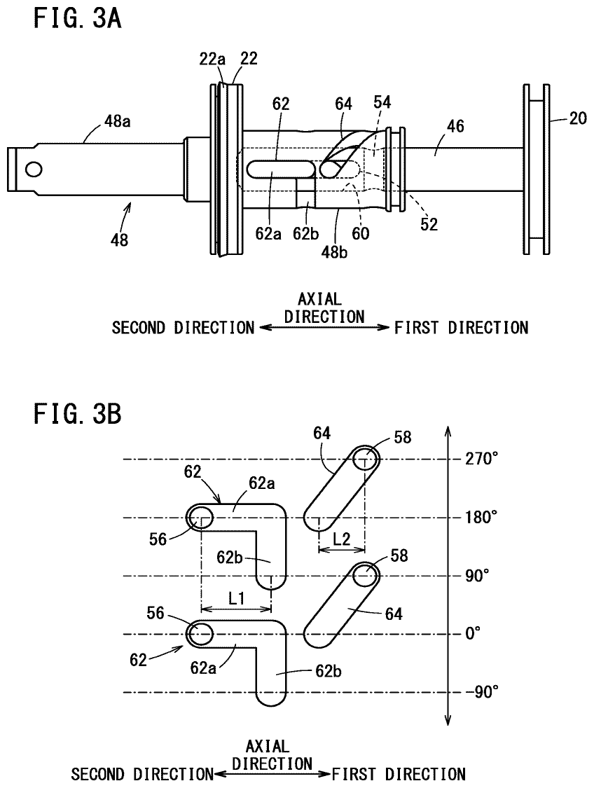

As shown in FIG. 3A, the cylindrical portion 48b includes a displacement switching groove 62 through which the support pin 56 is inserted, and a rotation groove 64 through which the link pin 58 is inserted. The displacement switching groove 62 and the rotation groove 64 extend in a radial direction from an outer circumferential surface of the cylindrical portion 48b to the shaft hole 60. As shown in FIG. 3B, two displacement switching grooves 62 are provided at an interval of 180 degrees in the circumferential direction. Further, two rotation grooves 64 are provided at an interval of 180 degrees in the circumferential direction.

The displacement switching grooves 62 each include an axially directed portion 62a that extends in the axial direction, and a circumferentially directed portion 62b that extends in the circumferential direction from an end part of the axially directed portion 62a in the first direction. More specifically, the displacement switching groove 62 has an L-shape as viewed from the side. A length L1 of the axially directed portion 62a in the axial direction is set, for example, to be one half of the stroke length of the first piston 20. The circumferentially directed portion 62b extends within an angular range of an angle of rotation (for example, 90 degrees) required for the rotational motion of the second rod 48.

The rotation grooves 64 each extend while being inclined at a predetermined angle with respect to the axial direction. A length L2 of the rotation groove 64 in the axial direction is set to be one half of the stroke length of the first piston 20. The angular range of the rotation groove 64 in the circumferential direction extends within the angular range of the angle of rotation required for the rotational motion of the second rod 48. More specifically, the angular range of the rotation groove 64 in the circumferential direction is the same as the angular range of the circumferentially directed portion 62b of the displacement switching groove 62. However, the rotation groove 64 is disposed at a position that is shifted by 90 degrees in the circumferential direction with respect to the circumferentially directed portion 62b. Further, the rotation groove 64 is disposed while being separated away in the first direction from the displacement switching groove 62.

The conversion mechanism 23 is constituted by the support pins 56, the link pins 58, the displacement switching grooves 62, and the rotation grooves 64. The support pin 56 is not displaced in the axial direction and the rotational direction with respect to the body 12. The support pin 56 is inserted into the displacement switching groove 62. The link pin 58 is capable of being displaced in the axial direction with respect to the body 12, but is not displaced in the rotational direction. The link pin 58 is inserted into the rotation groove 64.

The displacement switching groove 62 and the rotation groove 64, together with the second rod 48, are displaced in the axial direction and the rotational direction with respect to the body 12. The displacement switching groove 62 and the rotation groove 64 convert one part of the displacement of the link pin 58 in the axial direction into a displacement of the second rod 48 in the rotational direction. Further, the displacement switching groove 62 and the rotation groove 64 convert another part of the displacement of the link pin 58 in the axial direction into a displacement of the second rod 48 in the axial direction.

In a state in which the first piston 20 is positioned at an end part in the first direction (the retracted end position), the support pin 56 and the link pin 58 are disposed at the positions shown in FIG. 3B. More specifically, the support pin 56 is positioned at an end part of the axially directed portion 62a in the second direction, and the link pin 58 is positioned at an end part of the rotation groove 64 in the first direction.

The cylinder device 10 according to the present embodiment is configured in the manner described above. Hereinafter, a description will be given concerning operations thereof.

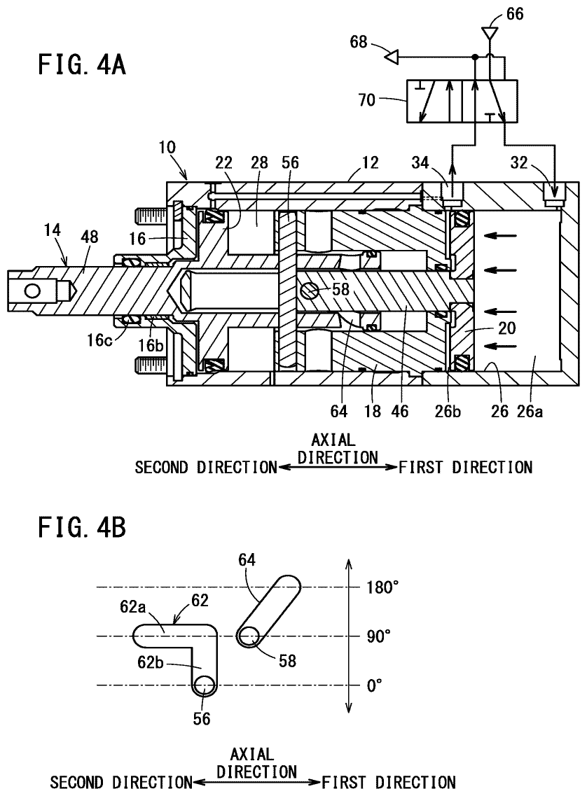

The cylinder device 10 performs a return operation from the retracted end position shown in FIG. 1 to the extruded end position shown in FIG. 4A. The return operation is carried out by connecting a pressurized fluid source 66 to the first fluid supply/discharge unit 32, and connecting the second fluid supply/discharge unit 34 to an exhaust unit 68. In accordance with this feature, the first piston 20 is driven toward the second direction, and the first piston 20 comes to a stop at the end part of the first cylinder chamber 26 in the second direction. The second rod 48 is driven in the second direction by the first rod 46, and the second piston 22 is disposed at the end part (the extruded end position) of the second cylinder chamber 28 in the second direction.

At the extruded end position, the second rod 48 projects out in the second direction, and further, is in a state of being rotated by 90 degrees in the circumferential direction from the state shown in FIG. 1. As shown in FIG. 4B, the support pin 56 is positioned at an end part of the circumferentially directed portion 62b of the displacement switching groove 62. Further, the link pin 58 is positioned at an end part of the rotation groove 64 in the second direction. Further, the second piston 22 is positioned in the expanded diameter portion 42 of the second cylinder chamber 28.

Next, a clamping operation of the second rod 48 of the cylinder device 10 is carried out. The clamping operation involves a rotational motion of the rod 14 at the extruded end, and a linear retracting motion of the rod 14 toward the retracted end. As shown in FIG. 5A, the clamping operation is carried out by connecting the exhaust unit 68 through an operation switching valve 70 to the first fluid supply/discharge unit 32, and by connecting the pressurized fluid source 66 to the second fluid supply/discharge unit 34. The pressurized fluid is supplied to the empty chamber 26b of the first cylinder chamber 26 through the second fluid supply/discharge unit 34, and the first piston 20 is displaced in the first direction. The first rod 46 is displaced in the first direction together with the first piston 20.

As a result, the first piston 20 moves from the extruded end position in FIG. 4A to the state (the rotation end position) shown in FIG. 5A. During this period, the second rod 48 undergoes a rotational displacement (a rotational motion). As shown in FIG. 5B, due to the displacement of the first rod 46 in the first direction, the link pin 58 moves in the first direction. The position of the link pin 58 in the circumferential direction is constant, and therefore, accompanying the movement of the link pin 58 in the first direction, the rotation groove 64 rotates so as to follow the link pin 58. As a result, the entirety of the second rod 48 rotates by −90 degrees in the circumferential direction, and the rotational motion of the rod 14 is carried out. Moreover, the second rod 48 is prevented, by the support pin 56 that is positioned in the circumferentially directed portion 62b, from being displaced in the axial direction. Accordingly, during the period until the support pin 56 moves to the axially directed portion 62a, the second rod 48 and the second piston 22 continue to rotate while remaining positioned at the end part in the second direction.

Accompanying the rotation of the second rod 48, the second piston 22 rotates together with the second rod 48. According to the present embodiment, the rotation of the second piston 22 is carried out in the expanded diameter portion 42. The expanded diameter portion 42 suppresses frictional resistance between the second piston 22 and the packing 22a at the time of the rotational motion. Accordingly, the second rod 48 can rotate with less force. Therefore, the expanded diameter portion 42 suppresses wearing between the link pin 58 and the rotation groove 64 that generate the rotational motion.

As shown in FIG. 5A, the expanded diameter portion 42, between itself and the outer circumferential part of the second piston 22, forms the leakage flow path 44 that allows the fluid in the second port 40 to be released to the empty chamber 28a side. The leakage flow path 44, during the period in which the second piston 22 carries out the rotational motion, prevents the second piston 22 from generating the driving force. Therefore, the expanded diameter portion 42, by preventing the generation of an increased pressure during the rotational motion of the second piston 22, prevents wearing from occurring between the support pin 56 and the circumferentially directed portion 62b. By providing such an expanded diameter portion 42, wearing of the conversion mechanism 23 can be prevented, and the useful service life of the cylinder device 10 can be extended.

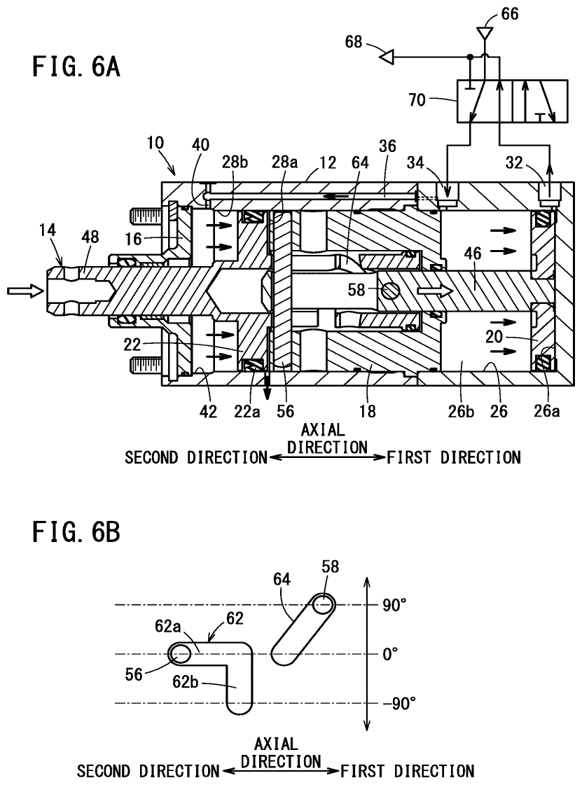

Next, a linear retracting motion of the rod 14 of the cylinder device 10 is carried out. As shown in FIG. 6A, in such a motion, the second rod 48 is displaced in the first direction together with the first rod 46. As shown in FIG. 6B, the displacement of the first rod 46 in the first direction is transmitted, via the link pin 58 and the rotation groove 64, to the second rod 48. Further, the support pin 56 is positioned in the axially directed portion 62a of the displacement switching groove 62, and therefore does not hinder the displacement of the second rod 48 in the axial direction. Therefore, the second rod 48 starts to be displaced in a manner so as to be retracted in the first direction.

When the second rod 48 is displaced a predetermined distance in the first direction, the packing 22a of the second piston 22 climbs over the expanded diameter portion 42, and moves to the first direction side of the expanded diameter portion 42. As a result, the second piston 22 partitions the second cylinder chamber 28 in a liquidtight and airtight manner. By the fluid that flows therein in from the second port 40, the pressure in the empty chamber 28b increases more than the pressure in the empty chamber 28a, and a driving force in the first direction is generated in the second piston 22. As a result, the second rod 48 is displaced in a manner so as to be retracted in the first direction by the driving force of the first piston 20, and the driving force of the second piston 22. At that time, the rod 14 generates a larger driving force.

In the cylinder device 10 of the present embodiment as described above, since the second piston 22 is connected to the second rod 48, the stroke range of the second piston 22 is limited to the stroke range of the second rod 48. Accordingly, in the present embodiment, the axial length of the second cylinder chamber 28 in which the second rod 48 is accommodated can be made shorter, and the overall length of the cylinder device 10 can be made shorter than in a case in which the second piston 22 is connected to the first rod 46.

### First Exemplary Modification of First Embodiment

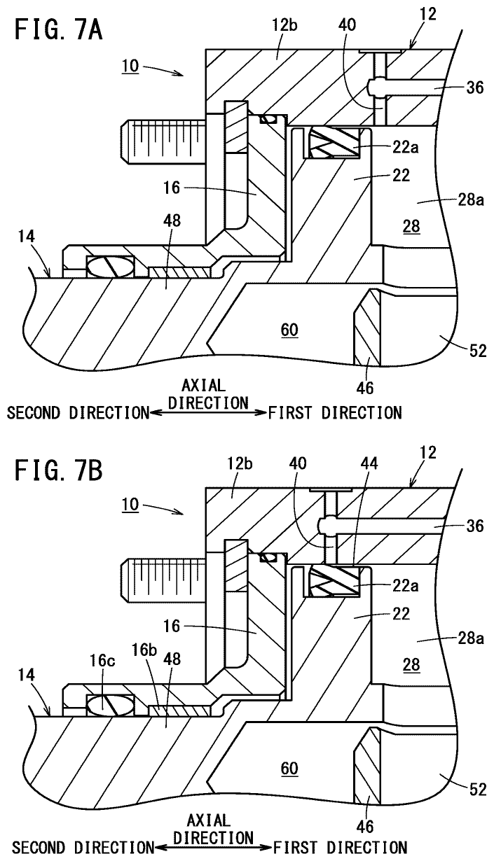

FIG. 7A shows the second cylinder chamber 28 and the second piston 22 at the extruded end position of the cylinder device 10 according to the first exemplary modification. In the present exemplary modification, at the extruded end position, the position of the opening of the second port 40 of the second cylinder chamber 28 is shifted toward the first direction side from the second port 40 that is shown in FIG. 1 to FIG. 6B. The second port 40 which is disposed in this manner, during the rotational displacement of the rod 14, is capable of preventing the generation of a driving force used for boosting in the second piston 22, and thereby prevents wearing of the displacement switching groove 62.

Further, in the present exemplary modification, a V-packing is preferably used as the packing 22a of the second piston 22. The V-packing is disposed in a manner so that a distal end part of the V character faces toward the first direction. The V-packing is maintained in a closed state until a pressure is applied to the empty chamber 28b on the second direction side, and therefore, even without providing the expanded diameter portion 42, frictional resistance when the second piston 22 rotates can be suppressed. Accordingly, in the present exemplary modification, the expanded diameter portion 42 does not need to be provided in the second cylinder chamber 28.

In the present exemplary modification, when the packing 22a of the second piston 22 is displaced further toward the first direction side than the second port 40, a driving force toward the first direction can be generated in the second piston 22. Since the cylinder device 10 of the present exemplary modification does not require the expanded diameter portion 42, the structure thereof is simplified.

### Second Exemplary Modification of First Embodiment

The present exemplary modification shown in FIG. 7B differs from the first exemplary modification (FIG. 7A) in relation to the position of the second port 40. In the present exemplary modification, the second port 40 is positioned more slightly toward the first direction side than the top part of the packing 22a on the outer circumferential side. In the present exemplary modification as well, since the gap between the packing 22a and the second cylinder chamber 28 serves as the leakage flow path 44, the generation of an increased pressure when the second piston 22 rotates can be prevented.

### Third Exemplary Modification of First Embodiment

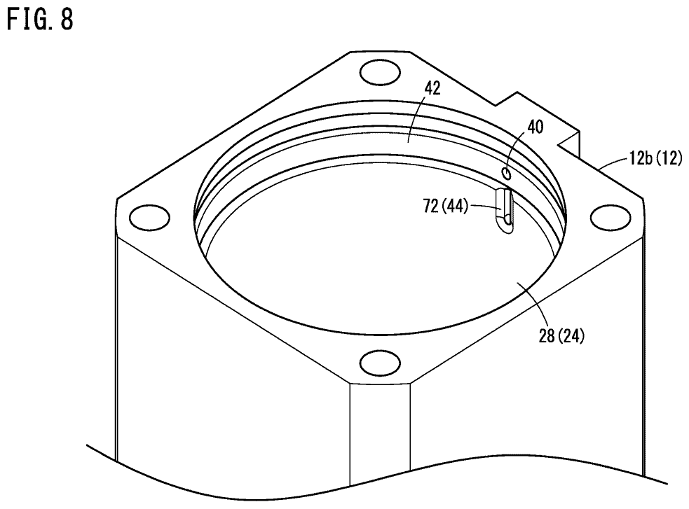

The cylinder device 10 according to the present exemplary modification, as shown in FIG. 8, includes an axially directed groove 72 that communicates with the expanded diameter portion 42 on the inner circumferential surface of the second cylinder chamber 28. The axially directed groove 72, in a state in which the second piston 22 is positioned at the extruded end position, constitutes the leakage flow path 44 that causes the fluid to leak from the second port 40. The cylinder device 10 of the present exemplary modification is capable of preventing the generation of an increased pressure during the rotational motion of the second piston 22. Moreover, although an example is shown in which the expanded diameter portion 42 and the axially directed groove 72 are provided, the present exemplary modification is not necessarily limited to this feature. Without providing the expanded diameter portion 42, the axially directed groove 72 may be provided in a manner so as to communicate with the second port 40.

### Second Embodiment

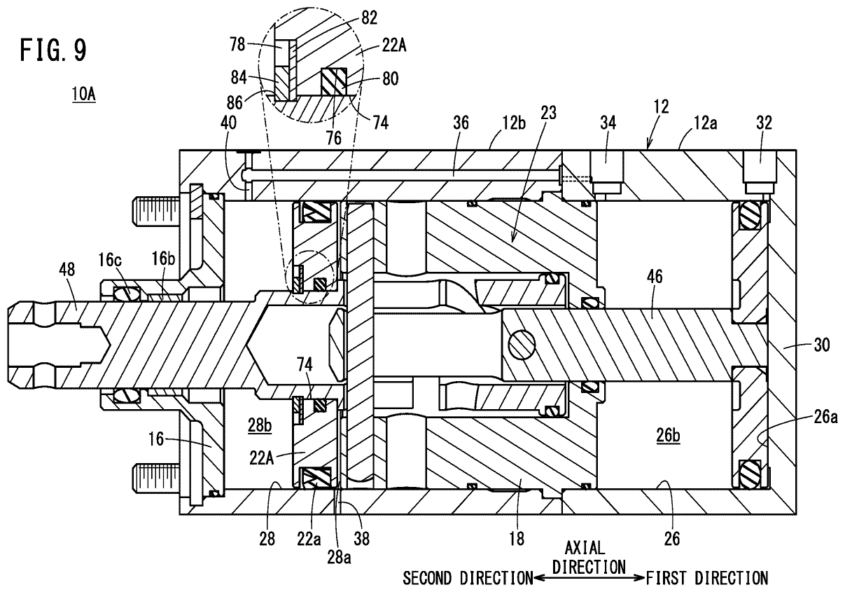

A cylinder device 10A according to the present embodiment shown in FIG. 9 differs from the cylinder device 10 shown in FIG. 1, in that a second piston 22A, which is capable of rotating with respect to the second rod 48, is provided. Moreover, in the cylinder device 10A shown in FIG. 9, the same constituent elements as those of the cylinder device 10 shown in FIG. 1 are denoted by the same reference numerals, and detailed description of such features will be omitted.

The second piston 22A includes, in the center thereof, a mounting hole 74 through which the second rod 48 can be inserted. The mounting hole 74 penetrates in the axial direction through the second piston 22A. The mounting hole 74 includes, on an inner circumferential part thereof, a packing mounting groove 76 and a stopper mounting groove 78. The packing mounting groove 76 is formed in close proximity to the center of the mounting hole 74 in the axial direction, and accommodates a packing 80 therein. The packing 80 prevents leakage of fluid along a gap between the inner circumferential part of the second piston 22A and the cylindrical portion 48b from occurring.

The stopper mounting groove 78 is positioned on an end part of the second piston 22A in the second direction. The stopper mounting groove 78 accommodates a ring-shaped stopper 82, and a fastener 84 therein. The stopper 82 and the fastener 84 engage with an engagement groove 86 that is formed on the outer circumferential surface of the second rod 48. The stopper 82 and the fastener 84 prevent displacement of the second piston 22A in the axial direction with respect to the second rod 48.

The second piston 22A according to the present embodiment is capable of rotating with respect to the second rod 48, and at the extruded end position, does not follow the rotational displacement of the second rod 48. Therefore, it becomes unnecessary to provide the expanded diameter portion 42 (refer to FIG. 1) on the inner circumferential surface of the second cylinder chamber 28. The cylinder device 10A according to the present embodiment, without providing the expanded diameter portion 42, is capable of preventing wearing from occurring between the link pin 58 and the rotation groove 64, and thus the structure of the cylinder device can be simplified.

### Exemplary Modification of Second Embodiment

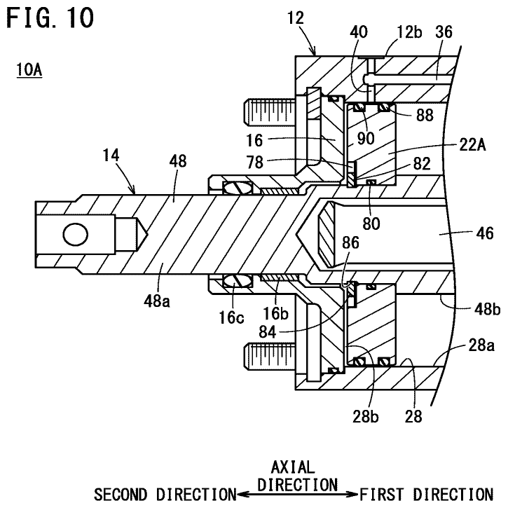

As shown in FIG. 10, the present exemplary modification includes the second piston 22A shown in FIG. 9. The second piston 22A according to the present exemplary modification includes, on the outer circumferential part thereof, a first packing 88 and a second packing 90 which are separated apart from each other in the axial direction. As shown in the figure, at the time when the second piston 22A is positioned at the stroke end part (the extruded end position) in the second direction, the first packing 88 is disposed between the second port 40 and the empty chamber 28a, and the second packing 90 is disposed between the second port 40 and the empty chamber 28b.

When the second rod 48 undergoes rotational displacement, the first packing 88 prevents leakage of the fluid into the empty chamber 28a. Further, the second packing 90 prevents leakage of the fluid into the empty chamber 28b, and thereby prevents the generation of the driving force used for boosting.

Accordingly, the cylinder device 10A according to the present exemplary modification, by preventing leakage of the fluid through the second cylinder chamber 28, is capable of suppressing the consumption amount of the fluid, and thereby makes it possible to reduce energy consumption.

### Third Embodiment

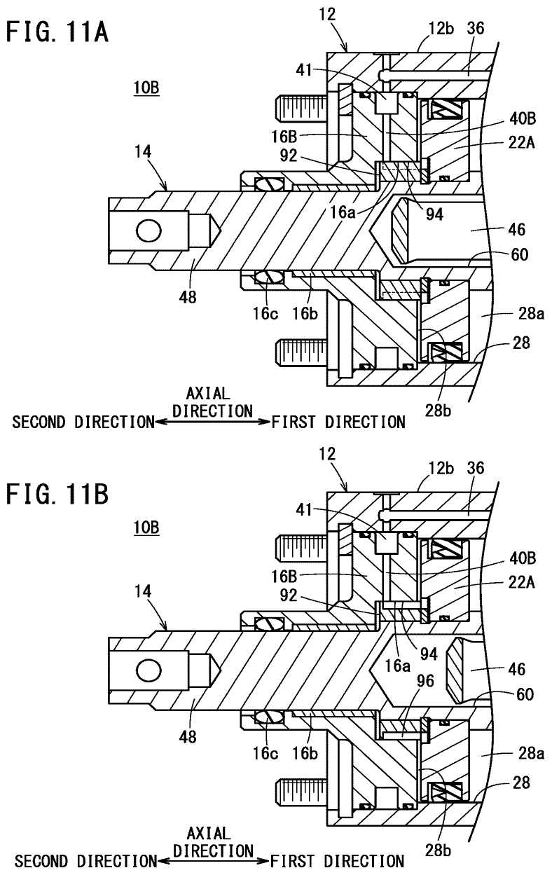

In a cylinder device 10B of the present embodiment shown in FIG. 11A and FIG. 11B, a second port 40B opens into the cover hole 16a of a rod cover 16B. Moreover, in the cylinder device 10B shown in FIG. 11A and FIG. 11B, the same constituent elements as those of the cylinder device 10A shown in FIG. 9 are denoted by the same reference numerals, and detailed description of such features will be omitted.

As shown in FIG. 11A, the cylinder device 10B includes the rod cover 16B, and a rotary valve 92. The rod cover 16B includes the second port 40B, and a cover flow path 94. The cover flow path 94 is a portion obtained by expanding the inner diameter of the cover hole 16a, and is positioned on the first direction side of the cover hole 16a. The inner diameter of the cover flow path 94 is larger than the outer diameter of the cylindrical portion 48b of the second rod 48. An end part of the cover flow path 94 on the first direction side opens toward the second cylinder chamber 28 (the empty chamber 28b).

The second port 40B is formed as a flow path that is formed in the interior of the rod cover 16B and extends in the radial direction. The second port 40B is disposed at a predetermined position in the circumferential direction of the body 12. An end part of the second port 40B on the inner circumferential side opens into the inner circumferential surface of the cover flow path 94. The rod cover 16B includes a circumferentially directed groove 41 on the outer circumferential part thereof. The circumferentially directed groove 41 is disposed at a position facing toward one end of the connecting flow path 36, and communicates with the connecting flow path 36. The circumferentially directed groove 41 extends over the entire circumference of the rod cover 16B in the circumferential direction. The second port 40B communicates via the circumferentially directed groove 41 with the connecting flow path 36.

The rotary valve 92 is a cylindrically shaped member that is mounted on the cylindrical portion 48b of the second rod 48. The rotary valve 92 is positioned on an end part of the cylindrical portion 48b in the second direction, and is mounted on an outer circumferential part of the cylindrical portion 48b. The rotary valve 92 is displaced in the rotational direction and the axial direction integrally together with the second rod 48. In a state in which the second rod 48 is positioned at the extruded end position, the rotary valve 92 is accommodated in the cover flow path 94. The rotary valve 92 is placed in intimate contact with the inner circumferential surface of the cover flow path 94, and thereby prevents communication between the second port 40B and the second cylinder chamber 28.

As shown in FIG. 11B, the rotary valve 92 includes a communication groove 96 that extends in the axial direction at a predetermined position in the circumferential direction. At the rotation end position of the second rod 48, the communication groove 96 of the rotary valve 92 is disposed at a position in the circumferential direction that coincides with the second port 40B. At the extruded end position of the rod 14, the rotary valve 92 seals the cover flow path 94 as shown in FIG. 11A. When the rotational motion of the rod 14 is completed, the rotary valve 92 rotates to the orientation shown in FIG. 11B. As shown in the figure, at the rotation end position, the second port 40B and the empty chamber 28b of the second cylinder chamber 28 communicate with each other through the communication groove 96.

Accordingly, the cylinder device 10B of the present embodiment is capable of preventing the generation of an increased force at the second piston 22A during the rotational motion of the rod 14, and can thereby prevent wearing of the displacement switching groove 62 and the support pin 56.

### First Exemplary Modification of Third Embodiment

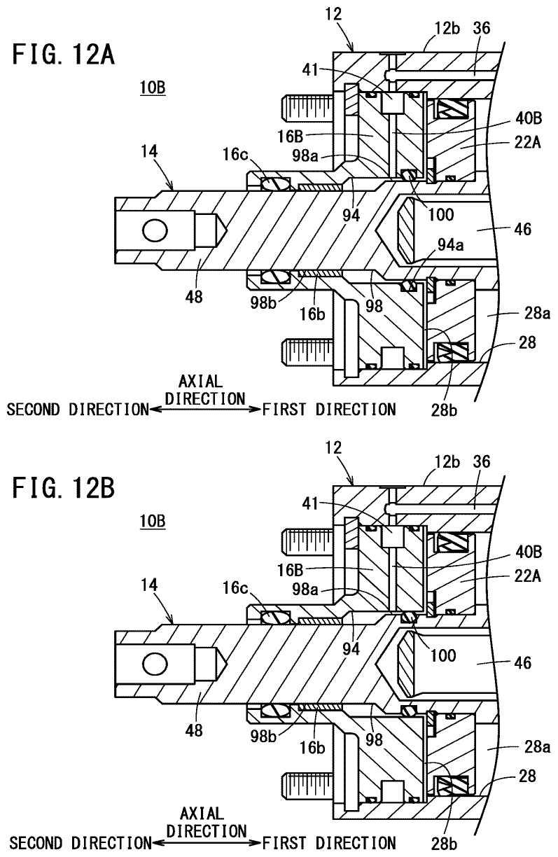

As shown in FIG. 12A, the cylinder device 10B of the present exemplary modification is, instead of the rotary valve 92, equipped with the second rod 48 having a stepped portion 98, and the rod cover 16B including the cover flow path 94 that is closed by the second rod 48. Moreover, it should be noted that a description concerning constituent elements that are the same as those of the cylinder device 10B shown in FIG. 11A will be omitted.

As shown in FIG. 12A, the rod cover 16B includes the cover flow path 94, and the second port 40B that opens into the cover flow path 94. A packing accommodation groove 94a is formed in the cover flow path 94 more on the first direction side than the opening of the second port 40B. A sealing packing 100 is mounted in the packing accommodation groove 94a.

The stepped portion 98 is provided on the second rod 48. The first direction side of the stepped portion 98 is formed as a large diameter portion 98a, and the large diameter portion 98a is connected to the cylindrical portion 48b. The large diameter portion 98a has a diameter that is slightly smaller than that of the cover flow path 94. At the extruded end position of the rod 14, the large diameter portion 98a is inserted into the cover flow path 94. An outer circumferential surface of the large diameter portion 98a is placed in intimate contact with the sealing packing 100, and thereby prevents communication between the second port 40B and the second cylinder chamber 28.

The second rod 48 includes a small diameter portion 98b on the second direction side of the stepped portion 98. The small diameter portion 98b has an outer diameter that is sufficiently smaller than the inner diameter of the sealing packing 100. When the second rod 48 is retracted and the stepped portion 98 moves further toward the first direction side than the cover flow path 94, the small diameter portion 98b forms, between itself and the cover flow path 94, a flow path through which the fluid is capable of flowing.

At the extruded end position of the rod 14 shown in FIG. 12A, the fluid in the second port 40B is sealed by the sealing packing 100 and the large diameter portion 98a. Accordingly, during the rotational motion of the rod 14, the second piston 22A does not generate a driving force used for boosting. Therefore, in the cylinder device 10B according to the present exemplary modification, it is possible to prevent wearing from occurring between the displacement switching groove 62 and the support pin 56.

Further, when the rotational displacement of the second rod 48 is completed, and the second rod 48 is displaced toward the first direction, the stepped portion 98 moves further toward the first direction side than the cover flow path 94. As a result, the second port 40B and the empty chamber 28b of the second cylinder chamber 28 are placed in communication with each other, and the fluid is supplied to the empty chamber 28b. A driving force used for boosting is capable of being generated in the second piston 22A.

### Second Exemplary Modification of Third Embodiment

The cylinder device 10B according to the present exemplary modification differs from the cylinder device 10B shown in FIG. 12A, in that the sealing packing 100 is disposed on the large diameter portion 98a side. Other features thereof are similar to those of the cylinder device 10B shown in FIG. 12A. In the present exemplary modification, when the large diameter portion 98a of the second rod 48 moves further toward the first direction side than the cover flow path 94, fluid is supplied to the second cylinder chamber 28, and the second piston 22A generates a driving force used for boosting.

The cylinder device 10B of the present exemplary modification exhibits the same advantageous effects as those of the cylinder device 10B shown in FIG. 12A.

The above disclosure can be summarized as in the following manner.

One aspect is the cylinder device including the first cylinder chamber including the first piston, the second cylinder chamber including the second piston, the first rod connected to the first piston, the second rod that partially overlaps with the first rod in the radial direction, and that projects out from the body, and the conversion mechanism that converts one part of the displacement of the first rod in the axial direction into the displacement of the second rod in the rotational direction, and that transmits another part of the displacement of the first rod in the axial direction as the displacement of the second rod in the axial direction, wherein the second piston is connected to the second rod.

In the above-described cylinder device, since the stroke length of the second piston can be shortened, the overall length of the second cylinder chamber can be reduced, and the overall length of the cylinder device can be made shorter.

In the above-described cylinder device, the conversion mechanism may be positioned between the first piston and the second piston. In such a cylinder device, since the second piston is disposed at a location that does not receive an influence of the stroke of the first piston, the stroke length of the second piston can be made shorter.

In the above-described cylinder device, the length of the second cylinder chamber in the axial direction may be shorter than the length of the first cylinder chamber in the axial direction. In such a cylinder device, the dimension in the axial direction thereof can be made smaller.

In the above-described cylinder device, the second cylinder chamber may have a larger inner diameter than the second piston, and may include the expanded diameter portion that causes the second piston at the extruded end position to separate away from the inner circumferential surface of the second cylinder chamber. In such a cylinder device, by suppressing the sliding resistance when the second piston undergoes the rotational displacement, wearing of the conversion mechanism can be suppressed.

In the above-described cylinder device, the expanded diameter portion may communicate with the chambers on both sides in the axial direction of the second piston at the extruded end position. In such a cylinder device, it is possible to prevent the driving force used for boosting from being generated in the second piston when the second piston undergoes the rotational displacement, and wearing of the conversion mechanism can be prevented.

The above-described cylinder device may further include the first port that opens into the end part of the second cylinder chamber in the first direction that is toward the retracted end position, and the second port that opens into the end part of the second cylinder chamber in the second direction that is toward the extruded end position. In such a cylinder device, it is possible to drive the second piston through the supply and discharge of the fluid between the first port and the second port.

In the above-described cylinder device, the second port may open into the second cylinder chamber at the position that is shifted in the first direction from the packing of the second piston at the extruded end position. In such a cylinder device, it is possible to prevent the driving force used for boosting from being generated in the second piston when the second piston undergoes the rotational displacement, and wearing of the conversion mechanism can be prevented.

In the above-described cylinder device, the second cylinder chamber may include, on the inner circumferential surface thereof, the leakage flow path that allows the fluid supplied from the second port to be released toward the side more in the first direction than the second piston. In such a cylinder device, it is possible to prevent the driving force used for boosting from being generated in the second piston when the second piston undergoes the rotational displacement, and wearing of the conversion mechanism can be prevented.

In the above-described cylinder device, the leakage flow path may be the groove formed on the inner circumferential surface of the second cylinder chamber and extending in the axial direction. In such a cylinder device, it is possible to prevent the driving force used for boosting from being generated in the second piston when the second piston undergoes the rotational displacement, and wearing of the conversion mechanism can be prevented.

The above-described cylinder device may further include the first fluid supply/discharge unit that opens on the side in the first direction of the first cylinder chamber, and the second fluid supply/discharge unit that opens on the side in the second direction of the first cylinder chamber, wherein the body may include the connecting flow path that connects the second fluid supply/discharge unit and the second port. In such a cylinder device, since the supply and discharge of the fluid to and from the second port can be performed through the second fluid supply/discharge unit, the number of pipes to be connected can be reduced.

The above-described cylinder device may further include the first packing disposed on the outer circumferential part of the second piston, and positioned on the side more in the first direction than the second port at the extruded end position of the second piston, and the second packing disposed on the outer circumferential part of the second piston, and positioned on the side more in the second direction than the second port at the extruded end position of the second piston. In such a cylinder device, it is possible to prevent leakage of the fluid at the extruded end, and the consumption amount of the pressurized fluid can be suppressed.

The above-described cylinder device may further include the rod cover including the cover hole through which the second rod is inserted, the cover flow path that is formed by the gap between the cover hole and the second rod, and that fluidly connects the second port and the second cylinder chamber, and the sealing packing that closes the cover flow path at the stroke end of the second rod in the second direction, and that opens the cover flow path and the second cylinder chamber when the second rod moves in the first direction. In such a cylinder device, it is possible to prevent leakage of the fluid at the extruded end, and the consumption amount of the pressurized fluid can be suppressed.

The above-described cylinder device may further include the rod cover including the cover hole through which the second rod is inserted, the cover flow path that is formed by the gap between the cover hole and the second rod, and that fluidly connects the second port and the second cylinder chamber, and the rotary valve that is disposed in the cover flow path, that rotates together with the second rod, and that opens the cover flow path when the second rod is positioned at the predetermined angle. In such a cylinder device, it is possible to prevent leakage of the fluid at the extruded end, and the consumption amount of the pressurized fluid can be suppressed.

In the above-described cylinder device, the second piston may be rotatably connected to the second rod. In such a cylinder device, since the sliding resistance of the rotational displacement of the second rod is small, wearing of the conversion mechanism can be effectively prevented.

Moreover, the present invention is not limited to the above disclosure, and various modifications are possible without departing from the essence and gist of the present invention.

1. A cylinder device, comprising:
a first cylinder chamber including a first piston;
a second cylinder chamber including a second piston;
a first rod connected to the first piston;
a second rod configured to partially overlap with the first rod in a radial direction, and to project out from a body; and
a conversion mechanism configured to convert one part of a displacement of the first rod in an axial direction into a displacement of the second rod in a rotational direction, and to transmit another part of the displacement of the first rod in the axial direction as a displacement of the second rod in the axial direction,
wherein the second piston is connected to the second rod.

2. The cylinder device according to claim 1, wherein the conversion mechanism is positioned between the first piston and the second piston.

3. The cylinder device according to claim 1, wherein a length of the second cylinder chamber in the axial direction is shorter than a length of the first cylinder chamber in the axial direction.

4. The cylinder device according to claim 1, wherein the second cylinder chamber has a larger inner diameter than the second piston, and includes an expanded diameter portion configured to cause the second piston at an extruded end position to separate away from an inner circumferential surface of the second cylinder chamber.

5. The cylinder device according to claim 4, wherein the expanded diameter portion communicates with chambers on both sides in the axial direction of the second piston at the extruded end position.

6. The cylinder device according to claim 1, further comprising:
a first port configured to open into an end part of the second cylinder chamber in a first direction that is toward a retracted end position; and
a second port configured to open into an end part of the second cylinder chamber in a second direction that is toward an extruded end position.

7. The cylinder device according to claim 6, wherein the second port opens into the second cylinder chamber at a position that is shifted in the first direction from a packing of the second piston at the extruded end position.

8. The cylinder device according to claim 6, wherein the second cylinder chamber includes, on an inner circumferential surface of the second cylinder chamber, a leakage flow path configured to allow a fluid supplied from the second port to be released toward a side more in the first direction than the second piston.

9. The cylinder device according to claim 8, wherein the leakage flow path is a groove formed on the inner circumferential surface of the second cylinder chamber and extending in the axial direction.

10. The cylinder device according to claim 6, further comprising:
a first fluid supply/discharge unit configured to open on a side in the first direction of the first cylinder chamber; and
a second fluid supply/discharge unit configured to open on a side in the second direction of the first cylinder chamber,
wherein the body includes a connecting flow path configured to connect the second fluid supply/discharge unit and the second port.

11. The cylinder device according to claim 6, wherein the second piston is rotatably connected to the second rod.

12. The cylinder device according to claim 10, further comprising:
a first packing disposed on an outer circumferential part of the second piston, and positioned on a side more in the first direction than the second port at the extruded end position of the second piston; and
a second packing disposed on the outer circumferential part of the second piston, and positioned on a side more in the second direction than the second port at the extruded end position of the second piston.

13. The cylinder device according to claim 10, further comprising:
a rod cover including a cover hole through which the second rod is inserted;
a cover flow path formed by a gap between the cover hole and the second rod, and configured to fluidly connect the second port and the second cylinder chamber; and
a sealing packing configured to close the cover flow path at a stroke end of the second rod in the second direction, and to open the cover flow path and the second cylinder chamber when the second rod moves in the first direction.

14. The cylinder device according to claim 10, further comprising:
a rod cover including a cover hole through which the second rod is inserted;
a cover flow path formed by a gap between the cover hole and the second rod, and configured to fluidly connect the second port and the second cylinder chamber; and
a rotary valve disposed in the cover flow path, and configured to rotate together with the second rod and open the cover flow path when the second rod is positioned at a predetermined angle.
